(19) United States
(12) Patent Application Publication
(10) Pub. No.: US 2006/0047776 A1
(43) Pub. Date: Mar. 2, 2006

(54) Automated failover in a cluster of geographically dispersed server nodes using data replication over a long distance communication link

(76) Inventors: Stephen Senh Chieng, Trabuco Canyon, CA (US); Carl Terence Drohomereski, Mission Viejo, CA (US); Chris B. Legg, Oceanside, CA (US); Brenda Ann Moreno, Mission Viejo, CA (US); Keith Louis Olshewski, San Jose, CA (US); Dennis Arthur Carlson, Huntington Beach, CA (US)

Correspondence Address: UNISYS CORP., 25725 JERONIMO ROAD, MS400, MISSION VIEJO, CA, 92691, US

(21) Appl. No.: 10/931,228

(22) Filed: Aug. 31, 2004

(51) Int. Cl. G06F 15/16

(52) U.S. Cl. 709/217

(57) ABSTRACT

An embodiment of the invention is a method for performing an automated failover from a remote server node to a local server node, the remote server node and the local server node being in a cluster of geographically dispersed server nodes. The local server node is selected to be recipient of a failover from a remote server node by a cluster service software. The local server node is coupled to a local storage system and a local replication module external to the local storage system. The remote server node is coupled to a remote storage system and a remote replication module external to the remote storage system. The local and remote replication modules are in long distance communication with each other to perform data replication between the local and remote storage systems. A controlling cluster resource is brought online at the local server node, the controlling cluster resource being a base dependency of dependent cluster resources in a cluster group. The state of the controlling cluster resource is set to online pending to delay the dependent cluster resources in the cluster group from going online at the local server node. Configuration information of the controlling cluster resource is then verified.

### BACKGROUND

1. Field of the Invention

Embodiments of the invention are in the field of clustered computer systems, and more specifically, relate to a method of providing a cluster of geographically dispersed computer nodes that may be located apart at distances greater than 300 kilometers.

2. Description of Related Art

A cluster is a group of computers that work together to run a common set of applications and appear as a single system to the client and applications. In a traditional cluster, the computers are physically connected by cables and programmatically connected by cluster software. These connections allow the computers to use failover and load balancing, which is not possible with a stand-alone computer.

Clustering, provided by cluster software such as Microsoft Cluster Server (MSCS) of Microsoft Corporation, provides high availability for mission-critical applications such as databases, messaging systems, and file and print services. High availability means that the cluster is designed so as to avoid a single point-of-failure. Applications can be distributed over more than one computer (also called node), achieving a degree of parallelism and failure recovery, and providing more availability. Multiple nodes in a cluster remain in constant communication. If one of the nodes in a cluster becomes unavailable as a result of failure or maintenance, another node is selected by the cluster software to take over the failing node's workload and to begin providing service. This process is known as failover. With very high availability, users who were accessing the service would be able to continue to access the service, and would be unaware that the service was briefly interrupted and is now provided by a different node.

The advantages of clustering make it highly desirable to group computers to run as a cluster. However, currently only computers that are not geographically dispersed can be grouped together to run as a cluster.

Currently, there exist systems in which computers that may be separated by more than 300 kilometers communicate with each other over a long distance communication link so that each of the computers can replicate the data being generated at another for its own storage. In such a system, the computers do not really form a cluster since there is no cluster software to provide the programmatic clustering with all the advantages described above. In such a geographically dispersed system, a manual failover of an application from one node to another node can be performed by a human administrator, but is very time-consuming, resulting in great amounts of application downtime.

Thus, it is desirable to have a technique for providing a cluster of geographically dispersed computer nodes that may be separated by more than 300 kilometers having the capability of automated failover.

### SUMMARY OF THE INVENTION

An embodiment of the invention is a method for performing an automated failover from a remote server node to a local server node, the remote server node and the local server node being in a cluster of geographically dispersed server nodes. The local server node is selected to be recipient of a failover from a remote server node by a cluster service software. The local server node is coupled to a local storage system and a local replication module external to the local storage system. The remote server node is coupled to a remote storage system and a remote replication module external to the remote storage system. The local and remote replication modules are in long distance communication with each other to perform data replication between the local and remote storage systems. A controlling cluster resource is brought online at the local server node, the controlling cluster resource being a base dependency of dependent cluster resources in a cluster group. The state of the controlling cluster resource is set to online pending to delay the dependent cluster resources in the cluster group from going online at the local server node. Configuration information of the controlling cluster resource is then verified.

### BRIEF DESCRIPTION OF THE DRAWINGS

The invention may best be understood by referring to the following description and accompanying drawings that are used to illustrate embodiments of the invention. In the drawings:

FIG. 1 is a diagram illustrating a prior art system 100 that includes a typical cluster.

FIG. 2 is a diagram illustrating a prior art system 200 for replicating data from a first server node to a second server node over a long distance communication link.

FIG. 3 is a block diagram illustrating an embodiment 300 of the system of the present invention.

FIG. 4 shows the information that forms the application 326 (respectively 356, FIG. 3) residing on node 310 (respectively, node 340) in one embodiment of the present invention.

FIG. 5 is a flowchart illustrating the process of performing an automated failover of an application from a server node 340 at a remote site to a server node 310 at a local site (FIG. 3) according to an embodiment of the present invention.

### DESCRIPTION

An embodiment of the invention is a method for performing an automated failover from a remote server node to a local server node, the remote server node and the local server node being in a cluster of geographically dispersed server nodes. The local server node is selected to be recipient of a failover from a remote server node by a cluster service software. The local server node is coupled to a local storage system and a local replication module external to the local storage system. The remote server node is coupled to a remote storage system and a remote replication module external to the remote storage system. The local and remote replication modules are in long distance communication with each other to perform data replication between the local and remote storage systems. A controlling cluster resource is brought online at the local server node, the controlling cluster resource being a base dependency of dependent cluster resources in a cluster group. The state of the controlling cluster resource is set to online pending to delay the dependent cluster resources in the cluster group from going online at the local server node. Configuration information of the controlling cluster resource is then verified.

If the configuration information is correct, the name of the local server node is determined, then a first command is sent from the controlling cluster resource to the local replication module to initiate the failover of data, then a second command is sent from the controlling cluster resource to the local replication module to check for completion of the failover of data. If the failover of data is completed successfully, the state of the controlling cluster resource is set to an online state to allow the dependent cluster resources in the cluster group to go online at the local server node. If the failover of data is not completed successfully, the state of the controlling cluster resource is set to a failed state to make the dependent cluster resources in the cluster group go offline at the local server node.

If the configuration information is not correct, the state of the controlling cluster resource is set to a failed state to make the dependent cluster resources in the cluster group go offline at the first server node.

In the following description, numerous specific details are set forth. However, it is understood that embodiments of the invention may be practiced without these specific details. In other instances, well-known circuits, structures, and techniques have not been shown in order not to obscure the understanding of this description.

Elements of one embodiment of the invention may be implemented by hardware, firmware, software or any combination thereof. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described above. The machine accessible medium may also include program code embedded therein. The program code may include machine-readable code to perform the operations described above. The term “data” here refers to any type of information that is encoded for machine-readable purposes. Therefore, it may include program, code, data, file, etc.

One embodiment of the invention may be described as a process, which is usually depicted as a flowchart, a flow diagram, a structure diagram, or a block diagram. Although a flowchart may describe the operations as a sequential process, many of the operations can be performed in parallel or concurrently. A loop or iterations in a flowchart may be described by a single iteration. It is understood that a loop index or loop indices or counter or counters are maintained to update the associated counters or pointers. In addition, the order of the operations may be re-arranged. A process terminates when its operations are completed. A process may correspond to a method, a program, a procedure, etc.

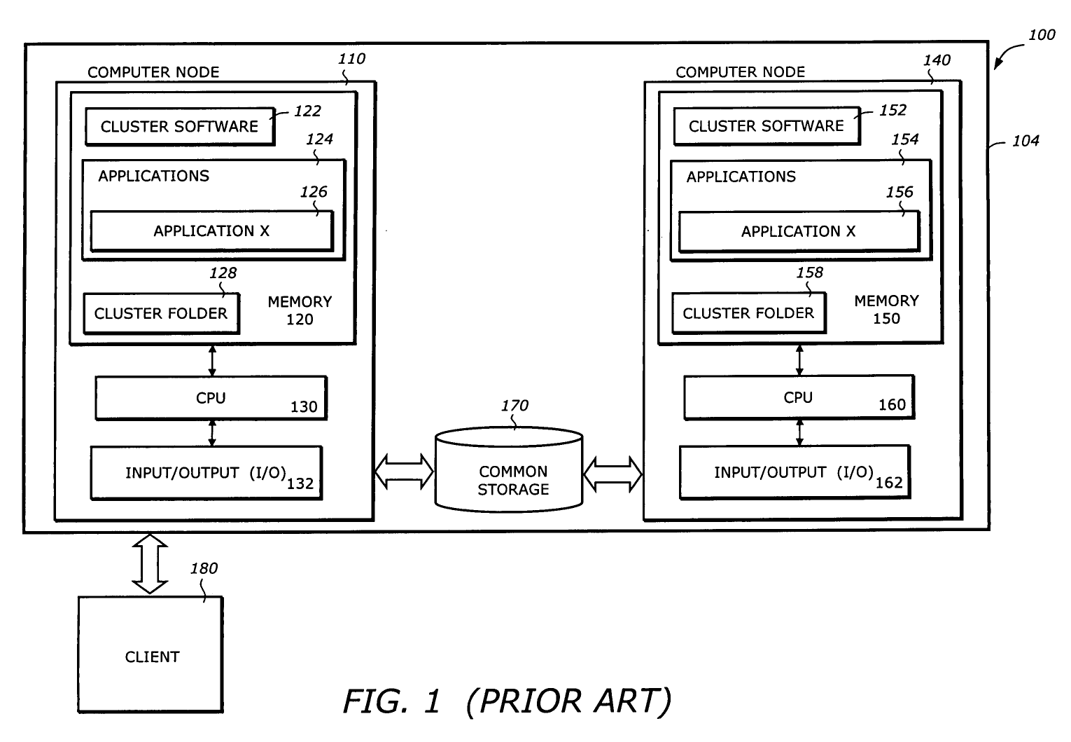

FIG. 1 is a diagram illustrating a prior art system 100 that includes a typical cluster. The system 100 includes a cluster 104 interfacing with a client 180.

The client 180 communicates with the cluster 104 via a communication network. The client can access an application running on the server system using the virtual Internet Protocol (IP) address of the application.

The cluster 104 includes a node 110, a node 140, and a common storage device 170.

Each of the nodes 110, 140 is a computer system. Node 110 comprises a memory 120, a processor unit 130 and an input/output unit 132. Similarly, node 140 comprises a memory 150, a processor unit 160 and an input/output unit 162. Each processor unit may include several elements such as data queue, arithmetic logical unit, memory read register, memory write register, etc.

Cluster software such as the Microsoft Cluster Service (MSCS) provides clustering services for a cluster. In order for the system 106 to operate as a cluster, identical copies of the cluster software must be running on each of the nodes 110, 140. Copy 122 of the cluster software resides in the memory 120 of node 110. Copy 152 of the cluster software resides in the memory 150 of node 140.

A cluster folder containing cluster-level information is included in the memory of each of the nodes of the cluster. Cluster-level information includes Dynamic Link Library (DLL) files of the applications that are running in the cluster. Cluster folder 128 is included in the memory 120 of node 110. Cluster folder 158 is included in the memory 150 of node 140.

A group of cluster-aware applications 124 is stored in the memory 120 of node 110. Identical copies 154 of these applications are stored in the memory 150 of node 140. For example, an identical copy 156 of application X 126 is stored in memory 150 of node 140.

Computer nodes 110 and 140 access a common storage 170. The common storage 170 contains information that is shared by the nodes in the cluster. This information includes data of the applications running in the cluster. Typically, only one computer node can access the common storage at a time.

The following describes a typical failover sequence. The typical failover sequence would take place in a typical cluster such as the cluster 104 shown in FIG. 1. The condition of an application such as application 126 running on node 110 deteriorates. One or more components of this application terminate due to the deteriorating condition, causing the application failure. After the application 126 on node 110 fails, the cluster software selects node 140 to take over the running of App 126. Node 140 senses the application failure, via the services of the cluster software 152 running on node 140. Node 140 initiates the takeover of the application 126 from node 110. Data for the failed application 126 is recovered from the common storage device 170. After the application data has been recovered, the application 126 is failed over to node 140, that is, continued execution of this application is now started on node 140 as execution of application 156. Depending on the point of failure during execution, the failed application may not be restarted exactly from the point of failure. The duration of application interruption, i.e., the application downtime, is from the termination of a component of the application to the start of continued execution of the application on node 140.

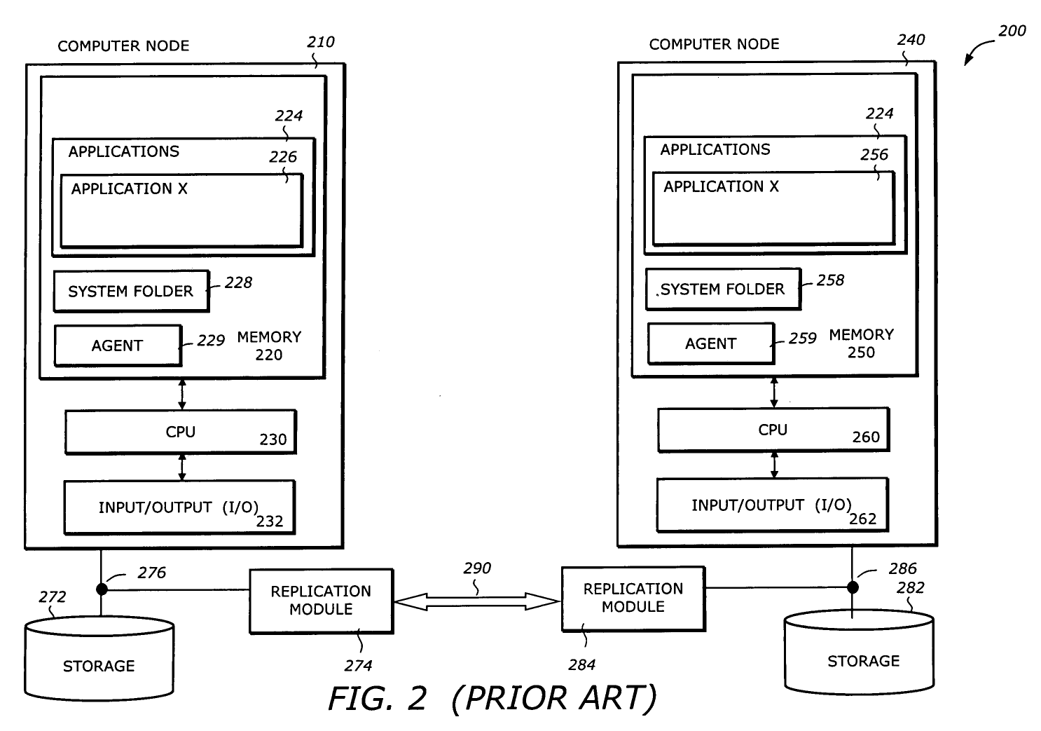

FIG. 2 is a diagram illustrating a prior art system 200 for replicating data from a first server node to a second server node over a long distance communication link. In this prior art system, the two server nodes are not programmatically connected by common cluster software. Thus, although there is data replication between the two server nodes, there is no automatic failover that would allow one server node to take over the functions of the other server node with negligible application downtime.

The prior art system 200 comprises a server node 210 coupled to a storage system 272 and a replication module 274 via a local network, a remote server node 240 coupled to a storage system 282 and a replication module 284 via a different local network. Each of the server nodes 210, 240 is a computer system. Node 210 comprises a memory 220, a processor unit 230 and an input/output unit 232. Similarly, node 240 comprises a memory 250, a processor unit 260 and an input/output unit 262. Each processor unit may include several elements such as data queue, arithmetic logical unit, memory read register, memory write register, etc.

A system folder containing information of the applications that are running on the computer node is stored in the computer memory. System folder 228 is stored in the memory 220 of node 210. System folder 258 is stored in the memory 250 of node 240.

A group of applications 224 is stored in the memory 220 of node 210. Identical copies 254 of these applications are stored in the memory 250 of node 240. For example, an identical copy 256 of application X 226 is stored in memory 250 of node 140.

An agent is stored in the computer memory to facilitate data replication between the two computer nodes 210, 240. Agent 229 is stored in memory 220 of computer node 210. Agent 259 is stored in memory 250 of computer node 240. The functions of the agents will be described later.

The replication module 274 communicates with the replication module 284 via a long distance communication link 290 such as a Wide Area Network, a Metropolitan Area Network, or dedicated communication lines. This long distance communication may be asynchronous or synchronous. Application data that is to be written to the storage system 272 is transferred from the server node 210 to both the storage system 272 and the replication module 274. The replication module 274 may include a compression module to compress the data, to save on bandwidth, before sending the data to the replication module 284 via the long distance communication link 290. The replication module 284 communicates with the server node 240 and the storage system 282 to write the data received over the long distance communication link 290 to the storage system 282.

The replication modules 274, 284 and software agents 229, 259 form a replication solution that allows data to be replicated between two different storage systems 272, 282 at geographically separated sites. The software agent 229 runs on the server 210 and splits all write commands to both the storage system 272 and the replication module 274 via the fibre channel switch 276. The replication module 274 sends this data over the long distance link 290 to the replication module 284. The replication module 284 sends the received data to the storage system 282 for storage, thus replicating data that are stored on storage system 272. Similarly, the software agent 259 runs on the server 240 and splits all write commands to both the storage system 282 and the replication module 284 via the fibre channel switch 286. The replication module 284 sends this data over the long distance link 290 to the replication module 274. The replication module 274 sends the received data to the storage system 272 for storage, thus replicating data that are stored on storage system 282. This replication solution allows manual application recovery when a crash occurs. An application could run on a server at each site and use the same data, since the data is constantly being replicated between sites. The replication solution may support both synchronous and asynchronous replication. The synchronous replication mode guarantees that data will be consistent between sites, but performs slowly at long distances. Asynchronous replication provides better performance over long distances. When a failure happens at one site, the user can manually start the application on a server at the other site. This allows the application to be available for access with some application downtime and requires human intervention.

An example of the replication solution described above is the Kashya KBX4000 Data Protection Appliance of Kashya Inc.

A consistency group is a group of disks that are being replicated by the replication modules. The replicated groups must be consistent with one another at any point in time. In general, one consistency group will be created for each application in the environment, containing all of the disks used by that application.

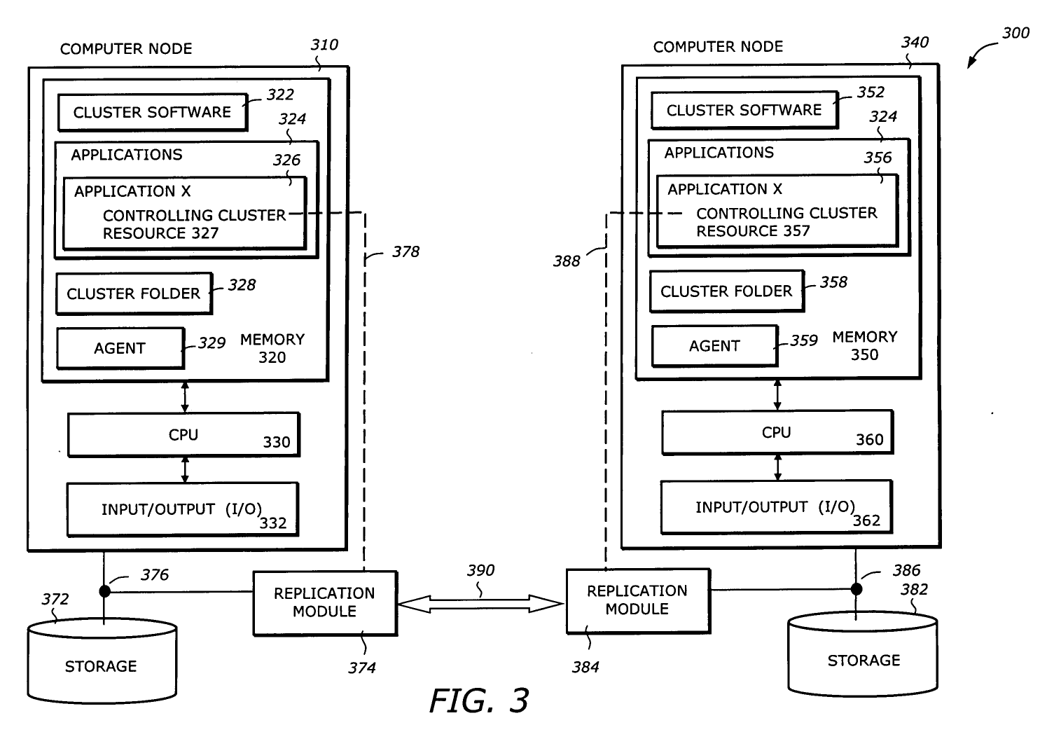

FIG. 3 is a block diagram illustrating an embodiment 300 of the system of the present invention. The system 300 comprises a server node 310 coupled to a storage system 372 and a replication module 374 via a local network, a server node 340 coupled to a storage system 382 and a replication module 384 via a different local network. The replication module 374 communicates with the replication module 384 via a long distance communication link 390 such as a Wide Area Network, a Metropolitan Area Network, or dedicated communication lines. This long distance communication may be asynchronous or synchronous. Application data that is to be written to the storage system 372 is transferred from the server node 310 to both the storage system 372 and the replication module 374. The replication module 374 may include a compression module to compress the data, to save on bandwidth, before sending the data to the replication module 384 via the long distance communication link 390. The replication module 384 communicates with the server node 340 and the storage system 382 to write the data received over the long distance communication link 390 to the storage system 382.

Each of the server nodes 310,340 is a computer system. Node 310 comprises a memory 320, a processor unit 330 and an input/output unit 332. Similarly, node 340 comprises a memory 350, a processor unit 360 and an input/output unit 362. Each processor unit may include several elements such as data queue, arithmetic logical unit, memory read register, memory write register, etc. Each processor unit 330, 360 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture. Each memory 320, 350 is typically implemented with dynamic random access memory (DRAM) or static random access memory (SRAM).

Cluster software such as the Microsoft Cluster Service (MSCS) provides clustering services for the cluster that includes server node 310 and 340. In order for the system 300 to operate as a cluster, identical copies of the cluster software are running on each of the nodes 310, 340. Copy 322 of the cluster software resides in the memory 320 of node 310. Copy 352 of the cluster software resides in the memory 350 of node 340.

A cluster folder containing cluster-level information is included in the memory of each of the nodes of the cluster. Cluster-level information includes Dynamic Link Library (DLL) files of the applications that are running in the cluster. Cluster folder 328 is included in the memory 320 of node 310. Cluster folder 358 is included in the memory 350 of node 340. The cluster folder also includes DLL files that represent a custom resource type that corresponds to the controlling cluster resource DLL of the present invention.

A group of cluster-aware applications 324 is stored in the memory 320 of node 310. Identical copies 354 of these applications are stored in the memory 350 of node 340. In particular, an identical copy 356 of application 326 that is stored in node 310 is stored in node 340. Application X 326 on node 310 also includes the controlling cluster resource 327 of the present invention. Respectively, application X 356 on node 340 includes the controlling cluster resource 357 of the present invention.

An agent is stored in the computer memory to facilitate data replication between the two computer nodes 310, 340. Agent 329 is stored in memory 320 of computer node 310. Agent 359 is stored in memory 350 of computer node 340.

The replication module 374 communicates with the replication module 384 via a long distance communication link 390 such as a Wide Area Network, a Metropolitan Area Network, or dedicated communication lines. This long distance communication may be asynchronous or synchronous. Application data that is to be written to the storage system 372 is transferred from the server node 310 to both the storage system 372 and the replication module 374. The replication module 374 may include a compression module to compress the data, to save on bandwidth, before sending the data to the replication module 384 via the long distance communication link 390. The replication module 384 communicates with the server node 340 and the storage system 382 to write the data received over the long distance communication link 390 to the storage system 382.

The replication modules 374, 384 and software agents 329, 359 form a replication solution that allows data to be replicated between two different storage systems 372, 382 at geographically separated sites. The software agent 329 runs on the server 310 and splits all write commands to both the storage system 372 and the replication module 374 via the fibre channel switch 376. The replication module 374 sends this data over the long distance link 390 to the replication module 384. The replication module 384 sends the received data to the storage system 382 for storage, thus replicating data that are stored on storage system 372. Similarly, the software agent 359 runs on the server 340 and splits all write commands to both the storage system 382 and the replication module 384 via the fibre channel switch 386. The replication module 384 sends this data over the long distance link 390 to the replication module 374. The replication module 374 sends the received data to the storage system 372 for storage, thus replicating data that are stored on storage system 382. This allows data to be replicated between sites. The replication solution may support both synchronous and asynchronous replication. The synchronous replication mode guarantees that data will be consistent between sites, but performs slowly at long distances. Asynchronous replication provides better performance over long distances.

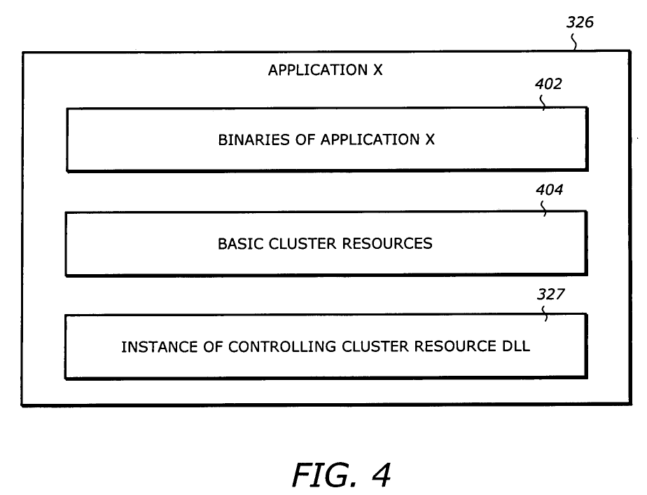

For clarity, the rest of FIG. 3 will be described in conjunction with the information from FIG. 4.

FIG. 4 shows the information that forms the application 326 (respectively 356, FIG. 3) residing on node 310 (respectively, node 340) in one embodiment of the present invention. The information that forms the application 326 comprises the binaries 402 of application X, the basic cluster resources 404, and the controlling cluster resource 327 of the present invention.

The binaries of application X are stored in the application X on each of the participating nodes of the cluster, while the data files of the application X are stored in each of the storage systems 372, 382 (FIG. 3).

When the application X is run on node 310, the application X 326 also comprises basic cluster resources 404 for the application X, and the controlling cluster resource 327 which is an instance of the custom resource type DLL of the present invention. The basic cluster resources 404 and the instance of the custom resource type 327 are logical objects created by the cluster at cluster-level (from DLL files).

The basic cluster resources 404 include a storage cluster resource identifying the storage 372, and application cluster resources which include an application Internet Protocol (IP) address resource identifying the IP address of the application X, and a network name resource identifying the network name of the application X. The application cluster resources are dependent on the storage cluster resource which in turn depends on the controlling cluster resource 327. Thus, the controlling cluster resource 327 is the base dependency of the basic cluster resources. This dependency means that, when the application is to be run on server node 310 of the cluster, the controlling cluster resource 327 in the corresponding cluster resource group is the one to be brought online first by the cluster service software 322.

The DLL files 327 for the custom resource type of the present invention include the controlling cluster resource DLL file and the cluster administrator extension DLL file. These DLL files are stored in the cluster folder 328 in node 310 (FIG. 3).

The controlling cluster resource DLL is configured with the consistency group that needs to controlled, the IP addresses of the replication modules and lists of the cluster nodes located at each site. This is included in the configuration information of the controlling cluster resource DLL.

Note that when the application X is run on the node 310 (i.e., application X is owned by node 310 at that time), an instance of the custom resource type as defined by these DLL files is created at cluster-level and stored in the application X 326.

A custom resource type means that the implemented resource type is different from the standard or out-of-the-box Microsoft cluster resource such as IP Address resource or WINS service resource. The behavior of the replication module is analyzed. Based on this behavior analysis, DLL files corresponding to and defining the custom resource type for the controlling cluster resource are created (block 304). These DLL files are used to send commands to the replication module to control its behavior.

In one embodiment of the invention, these custom resource DLL files are created using the Microsoft Visual C++® development system. Microsoft Corporation has published a number of Technical Articles for Writing Microsoft Cluster Server (MSCS) Resource DLLs. These articles describe in detail how to use the Microsoft Visual C++® development system to develop resource DLLs. Resource DLLs are created by running the “Resource Type AppWizard” of Microsoft Corporation within the developer studio. This builds a skeletal resource DLL and/or Cluster Administrator extension DLL. The skeletal resource DLL provides only the most basic capabilities. Based on the behavior of the replication module and the need of providing automated failover in a system such as the one shown in FIG. 3, the skeletal resource DLL is customized to produce the controlling cluster resource DLL.

When a failover of an application is to take place between two server nodes at two different geographic sites (that can be separated by a distance greater than 300 kilometers), the cluster service software requests the cluster resources for the application to go online at the server node that has been selected as the recipient of the failover. For example, server node 310 is selected as recipient of failover of application X 356 from server node 340. Since the controlling cluster resource 327 in the cluster resource group of the application X 326 is the base dependency of the basic cluster resources, the controlling cluster resource 327 is brought online first by the cluster service software 322. The controlling cluster resource 327 communicates with the replication module 374 using Secure Shell (SSH) protocol over a management network 378 to initiate and control the automated failover of application X from node 340 to node 310.

Similarly, the controlling cluster resource 357 on node 340 can communicate with the replication module 384 via the management network 388 to initiate and control automated failover when node 340 is selected as recipient of a failover of application X from another node.

Note that, in a different embodiment, the replication module 374 may be installed on the server node 310. In an embodiment having a smart storage system 372, the agent 329 may not be needed as part of the replication solution.

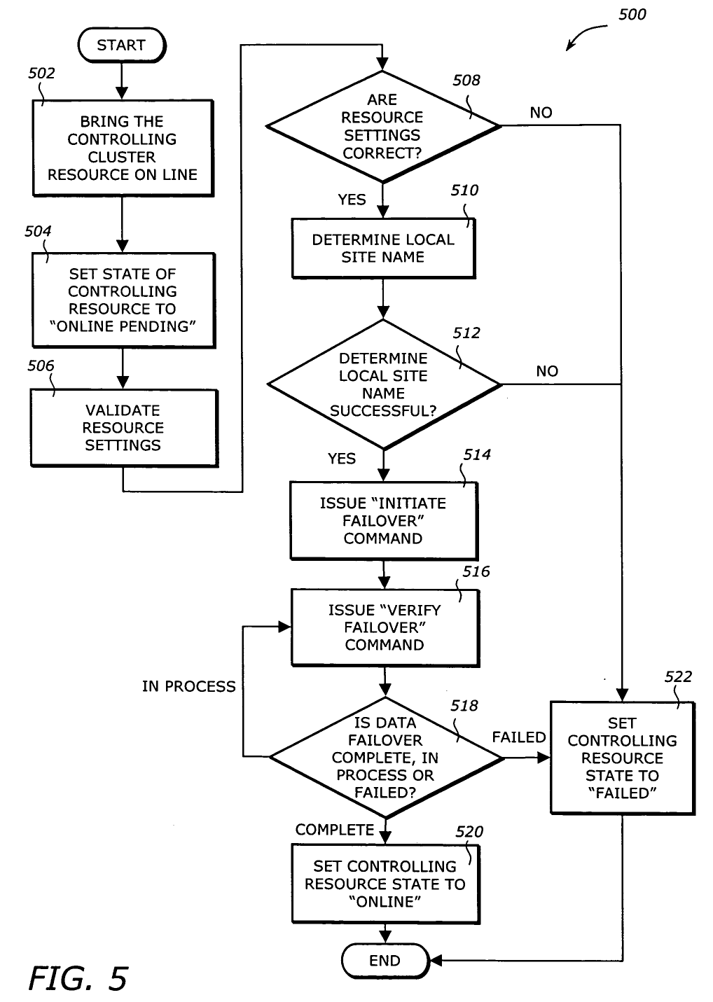

FIG. 5 is a flowchart illustrating the process of performing an automated failover of an application from a server node 340 at a remote site to a server node 310 at a local site (FIG. 3) according to an embodiment of the present invention.

Upon Start, process 500 brings the controlling cluster resource 327 of the application online at the local server node 310 (block 502). Process 500 sets the state of the controlling cluster resource 327 to “online pending” to keep the basic cluster resources 404 (FIG. 4) that depend on the controlling cluster resource in a pending state (block 504).

Using the controlling cluster resource 327, process 500 verifies the configuration information of the controlling cluster resource 327 with that of the configuration of the replication module 374 to ensure that no configuration problems would prevent the cluster resources from going online. Process 500 verifies that no other controlling cluster resources are controlling the same consistency group. Process 500 then sends the following commands from the controlling cluster rersource 327 to the replication module 374: “get_system_settings”, “get_group_settings” and “get_host_settings”. The returned output is parsed to verify that:
the configured IP address of the remote replication module is correct;
the configured consistency group exists;
the configured consistency group's “Stretched Cluster” value is set to “YES”;
the configured consistency group's “Failover Mode” value is set to “Automatic (Data)”;
the site node lists are correct.

From the above verification, process 500 determines whether the configuration information of the controlling cluster resource 327 is correct (block 508). If the configuration information of the controlling cluster resource 327 is not correct, process 500 sets the state of the controlling cluster resource 327 to the “Failed” state to prevent the dependent basic cluster resources 404 (FIG. 4) from going online at server node 310 (FIG. 3).

If the configuration information of the controlling cluster resource 327 is correct, process 500 determines the name of the local site server node that will receive the failover (block 510). This is done by comparing the local computer name to the names in the site node lists for the controlling cluster resource. If the computer name is found on a particular site node list, that site is to be the recipient of the failover of the consistency group from the remote server node. Note that determination of the name of the local site is needed because, when first brought online, the controlling cluster resource does not have such information. Process 500 checks whether the determination of the local site name is successful (block 512). If this determination of the local site name is not successful, process 500 sets the state of the controlling cluster resource 327 to the “Failed” state (block 522) to prevent the dependent basic cluster resources 404 (FIG. 4) from going online at server node 310 (FIG. 3).

If the determination of the local site name is successful, process 500 issues from the controlling cluster resource 327 an “initiate_failover” command to the local replication module 374 (FIG. 3) with the configured consistency group name and the site name that the consistency group should be available on (block 514). This command causes application data from the consistency group on storage device 382 at the remote side to failover to the storage device 372 at the local site via communication between the local replication module 374 and the remote replication module 384 over the long distance link 390 (FIG. 3).

Process 500 issues from the controlling cluster resource 327 a “verify_failover” command to the local replication module 374 with the configured consistency group name and the local site name (block 516). This command verifies that replication for the consistency group has completed and the data from the disk(s) is available on the storage 372 at the local site. Process 500 determines whether the failover of the application data is complete, or in process, or failed (block 518). If the application data failover is in process, process 500 loops back to block 516 to issue an other “verify_failover” command to the local replication module 374. In one embodiment, this command is resent every 60 seconds until either the command returns success, or failure, or the cluster resource timeout is reached.

If the application data failover is complete successfully, process 500 sets the state of the controlling cluster resource to “Online” (block 520) to allow the dependent basic cluster resources 404 (FIG. 4) to go online, then process 50l terminates.

If the application data failover is failed, process 500 sets the state of the controlling cluster resource 327 to the “Failed” state (block 522) to prevent the dependent basic cluster resources 404 (FIG. 4) from going online at server node 310 (FIG. 3), then process 500 terminates.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
selecting a first server node to be recipient of a failover from a second server node using a cluster service software, the first and second server nodes being programmatically connected by the cluster service software, the first server node being coupled to a first storage system and a first replication module external to the first storage system, the second server node being coupled to a second storage system and a second replication module external to the second storage system, the first and second replication modules being in communication with each other via a long distance communication link to perform data replication between the first and second storage systems;
bringing a controlling cluster resource online at the first server node, the controlling cluster resource being a base dependency of dependent cluster resources in a cluster group;
setting the state of the controlling cluster resource to online pending;
verifying configuration information of the controlling cluster resource;
if the configuration information is correct,
determining the name of the first server node;
sending a first command from the controlling cluster resource to the first replication module to initiate failover of data; and
sending a second command from the controlling cluster resource to the local replication module to check for completion of failover of data.

2. The method of claim 1 further comprising, if the configuration information is correct:
if the failover of data is completed successfully,
setting the state of the controlling cluster resource to online state to allow the dependent cluster resources in the cluster group to go online at the first server node;
else,
setting the state of the controlling cluster resource to failed state to prevent the dependent cluster resources in the cluster group from going online at the first server node.

3. The method of claim 1 further comprising:
if the configuration information is not correct,
setting the state of the controlling cluster resource to failed state to prevent the dependent cluster resources in the cluster group from going online at the first server node.

4. The method of claim 1 wherein verifying configuration information of the controlling cluster resource comprises verifying IP addresses of first and second replication modules, identity of a consistency group, and lists of cluster nodes located at each of the first and second server nodes.

5. The method of claim 1 wherein the dependent cluster resources in the cluster group comprise application cluster resources and a physical storage disk cluster resource.

6. The method of claim 1 wherein the controlling cluster resource communicates with the first replication module via a secure shell protocol over a management network.

7. The method of claim 1 wherein the first replication module communicates with the first server node via a fibre channel switch.

8. The method of claim 1 wherein the first and second replication modules communicate with each other asynchronously.

9. A system comprising:
a first server node including a controlling cluster resource and dependent cluster resources in a cluster group, the controlling cluster resource being a base dependency of the dependent cluster resources in the cluster group;
a first storage system coupled to the first server node;
a first replication module coupled to the first server node, the first replication module being external to the first storage system;
a second server node including a copy of the controlling cluster resource and copies of the cluster resources in the cluster group;
a second storage system coupled to the second server node;
a second replication module coupled to the second server node, the second replication module being external to the second storage system;
wherein the first and second server nodes are programmatically connected by a cluster service software, and the first server node is selected by the cluster service software to be recipient of a failover from the second server node, the first and second replication modules are in communication with each other via a long distance communication link to perform data replication between the first and second storage systems, and wherein the controlling cluster resource controls the failover.

10. The system of claim 9 wherein the controlling cluster resource communicates with the first replication module via a management network to control the failover.

11. The system of claim 10 wherein the controlling cluster resource sends a first command to the first replication module to initiate failover of data.

12. The system of claim 11 wherein the controlling cluster resource sends a second command to the first replication module to check for completion of failover of data.

13. The system of claim 9 wherein the state of the controlling cluster resource is set to online pending state to keep the dependent cluster resources in the cluster group in pending state at the first server node.

14. The system of claim 9 wherein the state of the controlling cluster resource is set to online state to allow the dependent cluster resources in the cluster group to go online at the first server node.

15. The system of claim 9 wherein the state of the controlling cluster resource is set to failed state to prevent the dependent cluster resources in the cluster group from going online at the first server node.

16. The system of claim 9 wherein the dependent cluster resources in the cluster group comprise application cluster resources and a physical storage disk cluster resource.

17. An article of manufacture comprising:
a machine-accessible medium including data that, when accessed by a machine, cause the machine to perform operations comprising:
selecting a first server node to be recipient of a failover from a second server node, the first and second server nodes being programmatically connected by a cluster service software, the first server node being coupled to a first storage system and a first replication module external to the first storage system, the second server node being coupled to a second storage system and a second replication module external to the second storage system, the first and second replication modules being in communication with each other via a long distance communication link to perform data replication between the first and second storage systems;
bringing a controlling cluster resource online at the first server node, the controlling cluster resource being a base dependency of dependent cluster resources in a cluster group;
setting the state of the controlling cluster resource to online pending;
verifying configuration information of the controlling cluster resource;
if the configuration information is correct,
determining the name of the first server node;
sending a first command from the controlling cluster resource to the first replication module to initiate failover of data; and
sending a second command from the controlling cluster resource to the local replication module to check for completion of failover of data.

18. The article of manufacture of claim 17 wherein, if the configuration information is correct, the data further comprise data that, when accessed by the machine, cause the machine to perform operations comprising:
if the failover of data is completed successfully,
setting the state of the controlling cluster resource to online state to allow the dependent cluster resources in the cluster group to go online at the first server node;
else,
setting the state of the controlling cluster resource to failed state to prevent the dependent cluster resources in the cluster group from going online at the first server node.

19. The article of manufacture of claim 17 wherein, if the configuration information is not correct, the data further comprise data that, when accessed by the machine, cause the machine to perform operations comprising:
setting the state of the controlling cluster resource to failed state to prevent the dependent cluster resources in the cluster group from going online at the first server node.

20. The article of manufacture of claim 17 wherein the data causing the machine to perform the operation of verifying configuration information of the controlling cluster resource comprise data that, when accessed by the machine, cause the machine to perform operations comprising:
verifying IP addresses of first and second replication modules, identity of a consistency group, and lists of cluster nodes located at each of the first and second server nodes.
